(19) United States
(12) Patent Application Publication
(10) Pub. No.: US 2025/0229662 A1
(43) Pub. Date: Jul. 17, 2025

(54) CIRCULATING TURBINE SYSTEM FOR ELECTRIC VEHICLES, CIRCULATING DUAL BATTERY, AND TURBINE CHARGING SYSTEMS

(71) Applicant: Charlie E. JONES, Portsmouth, VA (US)

(72) Inventor: Charlie E. JONES, Portsmouth, VA (US)

(21) Appl. No.: 19/020,374

(22) Filed: Jan. 14, 2025

Related U.S. Application Data
(60) Provisional application No. 63/621,218, filed on Jan. 16, 2024.

(51) Int. Cl. B60L 53/52; B60L 53/60

(52) U.S. Cl. CPC B60L 53/52; B60L 53/60

(57) ABSTRACT

An on-board charging system for an electric vehicle includes wind turbines that intercept wind created by motion of the vehicle, to generate electricity. The vehicle has two batteries, a first one of which supplies power to the vehicle's motor. A controller connects the output terminal of the wind turbines to the second battery, to charge that battery while the vehicle is in motion. When the charge level of the first battery falls to a specified level, the controller switches the connections of the two batteries to connect the first battery to the wind turbines and the second, charged battery to the motor. The controller also controls the operation of the turbines based upon the speed of the vehicle, and controls the flow of air to the turbines.

### RELATED APPLICATION

The priority benefit of U.S. Provisional Application Ser. No. 63/621,218, filed Jan. 16, 2024, entitled “Ev-Vehicles Turbine System,” which is incorporated herein by reference in its entirety, is claimed.

### FIELD OF THE INVENTION

The present invention relates to an electric vehicle (EV) recharging system. More particularly, the invention relates to an on-board supplemental system for charging one or more batteries of an electric vehicle while the vehicle is in motion.

### BACKGROUND OF THE INVENTION

Charging systems are known for electric vehicles. Most charging systems comprise charging stations at home or at commercial facilities to charge EV batteries while the vehicle is stationary. The time required to charge the battery can be considerable, e.g., on the order of one-half hour to four or more hours, depending upon the type of charger. Consequently, the vehicle owner is not able to use the vehicle for its intended purpose during this lengthy period of time.

### OBJECTS OF THE INVENTION

An object of the present invention is to provide a recharging system for an electric vehicle which enables its battery to be charged while the vehicle is being used for transportation purposes.

This and other objects of the invention will be apparent from the following description of preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, wherein like structures are indicated by like reference numbers.

Referring to the drawings:

FIG. 1 illustrates a front view of a vehicle in which the principles of the present invention can be incorporated.

FIG. 2 depicts a front view of the vehicle with its grille removed, illustrating a set of closed vanes that regulate airflow into the front of the vehicle.

FIG. 3 is further front view of the vehicle with the vanes removed, to illustrate turbines within an air duct of the vehicle.

FIG. 4 is another front view of the vehicle illustrating the vanes in an open position to permit air to flow to the turbines.

FIG. 5 is a side view of the vehicle illustrating air flow through the air duct.

FIG. 6 is an overhead view illustrating the arrangement of the vanes and turbines within the air duct.

FIG. 7 is a block diagram of the electrical system for controlling the charging of the vehicle's batteries.

### DETAILED DESCRIPTION OF PREFERRED EMBODIMENTS

An electric vehicle recharging system for a motor vehicle is disclosed. In an exemplary embodiment, propeller turbine generators are located behind the front grille of the vehicle. While the vehicle is being driven, its forward motion creates relative air movement that turns the blades of the turbines, to generate electricity. This electricity is applied to a battery in the vehicle to recharge it while the vehicle is being driven. Once the vehicle's battery reaches a designated charge level, the battery is disconnected from the turbines, and is able to provide power for running the vehicle.

Once the charge level of the vehicle battery decreases to a designated percentage, for example 20%, the turbine is reconnected and reinitiates charging until the battery is fully charged again. This process can be continually repeated until the vehicle is no longer being driven.

When the vehicle is restarted and is moving forward, wind that enters through a vent in the front of the vehicle provides sufficient power to rotate the turbine's blades. When the turbine rotates, it generates electricity. The battery's current charge level indicates whether charging is needed. If so, voltage from the turbine is supplied to the battery until the vehicle is fully charged, at which time the turbine power is disconnected and stops charging the battery. This process can be repeated while the vehicle is traveling. As such, the need for the vehicle to stop and recharge at fixed EV charging station locations can be eliminated, or at least substantially reduced.

Since the vehicle charges while moving, current drainage from the electrical grid is reduced by allowing the vehicle to be self-energized. This feature also saves time for a vehicle's passengers by avoiding the need to pull over to recharge the vehicle while traveling to reach their destination, in a safe and timely manner without interruption.

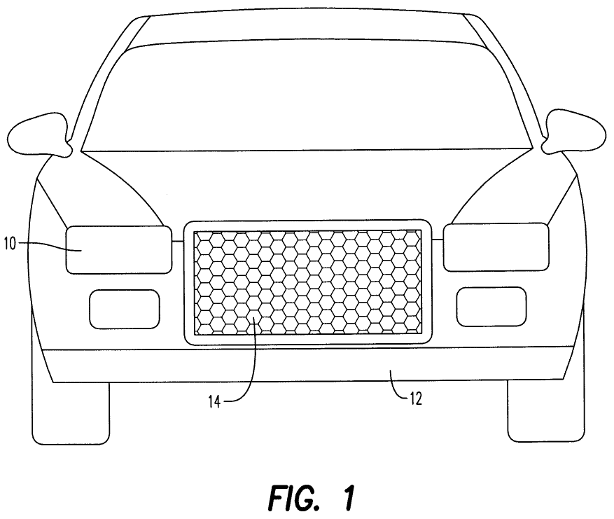

FIG. 1 is a front view of an exemplary electric vehicle in which the principles of the present invention can be implemented, in this case a standard sedan. It will be appreciated, however, that the principles of the invention are not limited to this particular style of vehicle, and can be applied to any type of electric vehicle.

As is typical, the front of the vehicle includes headlights 10, a bumper 12, and a grille 14. Located behind the grille is a compartment 20 which corresponds to the engine compartment of a conventional non-electric or hybrid vehicle.

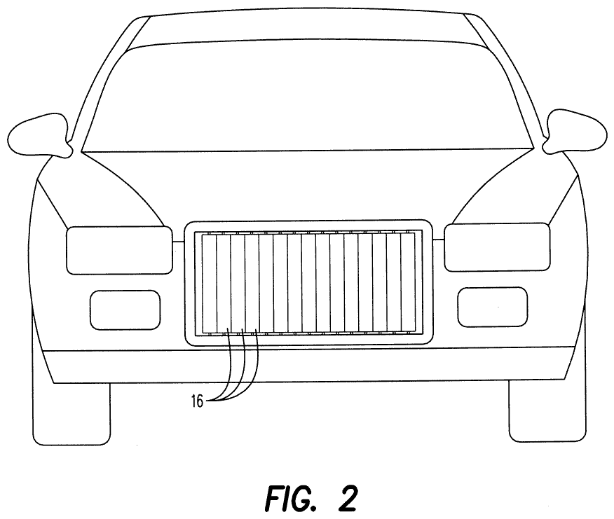

FIG. 2 is another front view of the vehicle 10, with the grille removed. A set of movable barriers 16, e.g., movable vanes, are positioned behind the grille. These vanes are controllable, to regulate the movement of air into the compartment as the vehicle is moving forward. For instance, each vane can be rotated about a vertical axis to adjust the amount of air flowing into the compartment. As illustrated in FIG. 2, the vanes can be oriented parallel to the front of the vehicle, in a closed position to block the flow of air into the compartment. Conversely, they can be positioned perpendicular to the front of the vehicle, to allow air to flow freely into the compartment, at a rate corresponding to the speed of the vehicle. By selectively positioning the vanes between the parallel and perpendicular positions, the rate of flow of the air into the compartment can be regulated.

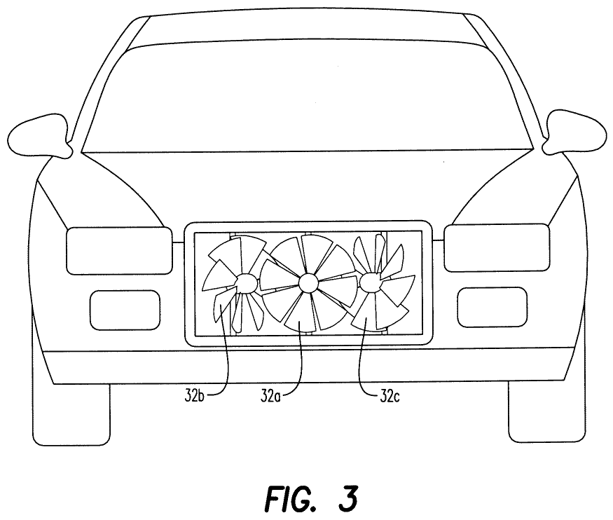

FIG. 3 is another front view of the vehicle, with both the grille 14 and vanes 16 removed. As illustrated therein, three wind turbines 32a, 32b and 32c are located within the compartment. The compartment contains an air duct, and the turbines are positioned across the width of the duct to maximize the amount of wind that is captured by the blades of the turbines. It will be appreciated that, depending on the shape and size of the vehicle's compartment, the number of wind turbines can be varied to achieve this objective.

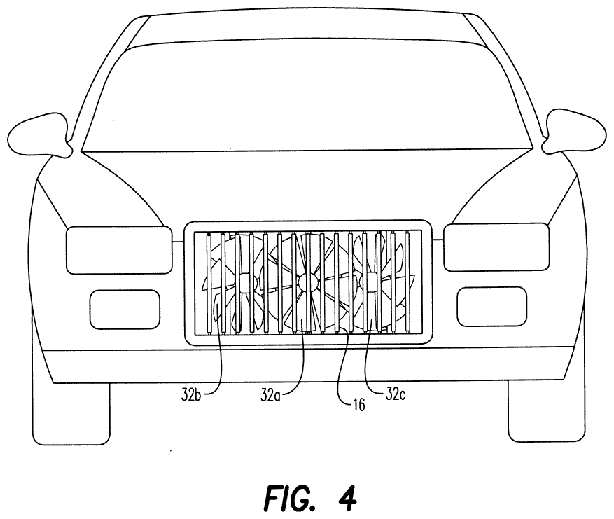

FIG. 4 is another front view of the vehicle depicting the vanes 16 in a fully open position. In this position, the maximum amount of airflow resulting from the vehicle's speed impacts upon the blades of the turbines to generate electricity.

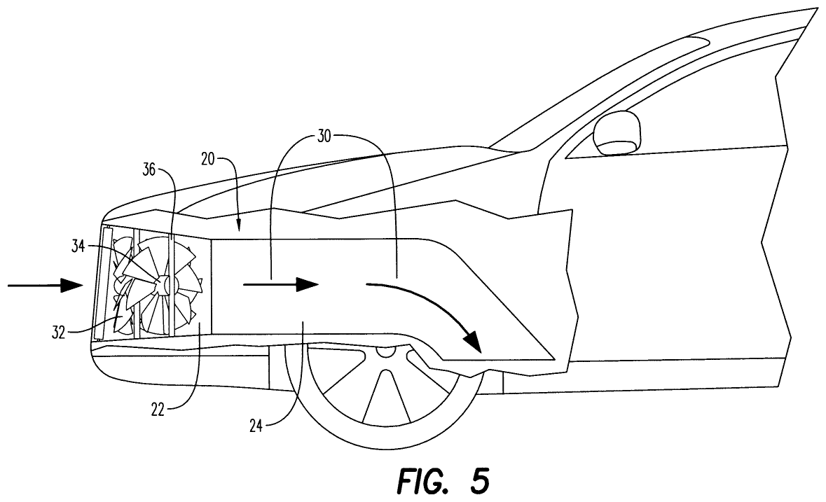

FIG. 5 is a side view of the vehicle, with the fender removed, to show an enclosed air duct system within the compartment 20. The air duct system includes a wind turbine section 22, and an exhaust section 24. When the vehicle is moving forward, its movement relative to the air creates wind that flows into and through the wind turbine section 24, and out the exhaust section, as indicated by the arrows 30.

As shown in FIG. 5, the motor 34 of each wind turbine is mounted on a vertical rod 36 that is attached to suitable structural supports within the vehicle. For example, the lower end of each rod can be attached to the frame of the vehicle, or a strut that spans the frame. The upper end of each rod can be attached to one or more bars that are attached to the sides of the wind turbine section 22.

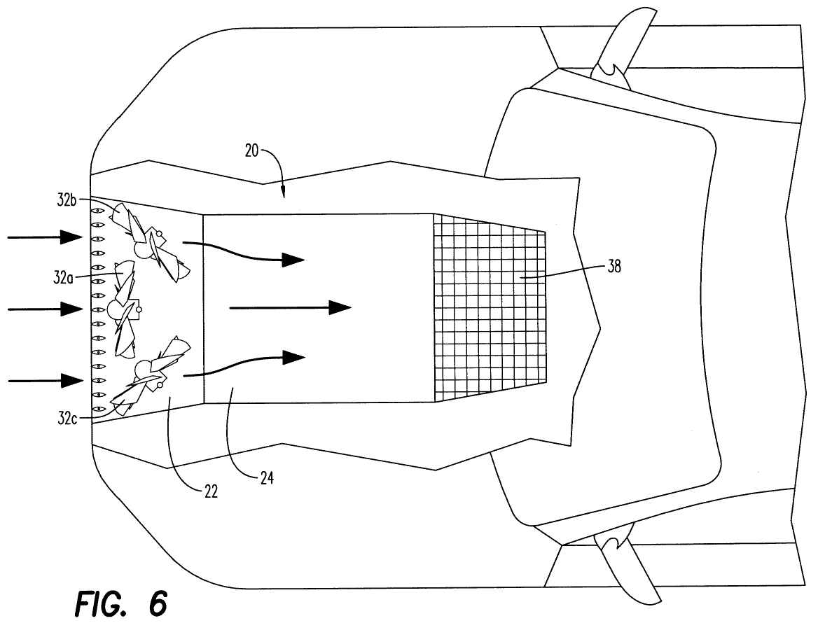

FIG. 6 is an overhead view of the compartment 20, with the top covers of the turbine section 22 and the exhaust section 24 removed, to illustrate the arrangement of the wind turbines 32 within the duct. A first turbine 32a is located at the front of the duct section 22, and faces directly forward. The other two turbines 32b and 32c are located behind the first turbine, and oriented at an angle relative to the first turbine, e.g., approximately 45 degrees. The outer portions of the blades for the turbines 32b and 32c intercept wind in respective lateral portions of the section 22 that is not intercepted by the blades of the central turbine 32a.

In operation, air entering the front grille of the vehicle flows to the back of the air duct and into the atmosphere through a screen 38 at the bottom of the exhaust section. The air flow is preferably unobstructed from the front to the back of the compartment to obtain maximum air flow effect.

The turbine motors 34 are waterproof. In an exemplary embodiment, the motor of each wind turbine can be a 12000 W gearless permanent magnet generator capable of generating 12V, 24V, 48V, 120V and 220V of power. This output is sufficient to charge a battery within a time period of 20-30 minutes.

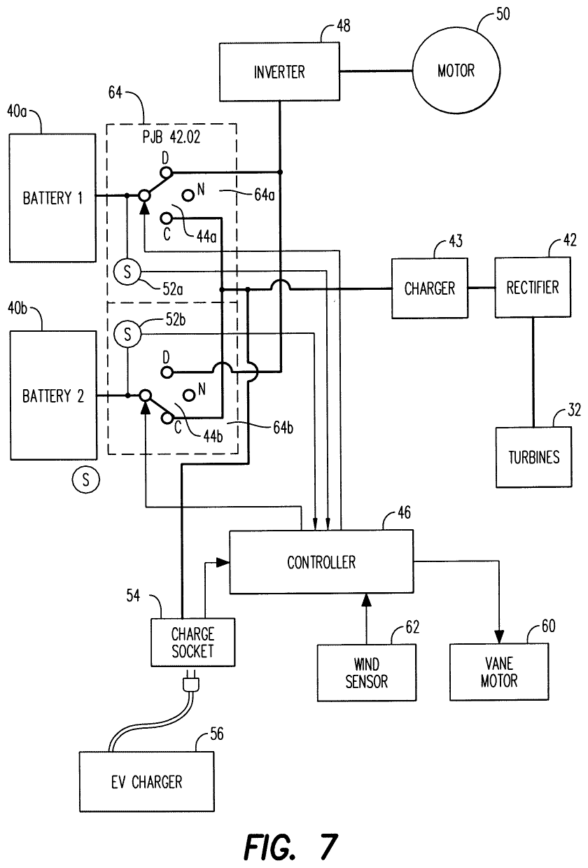

FIG. 7 is a block diagram of the system for controlling the on-board recharging system, and integrating it with the vehicle's standard charging system. The bold lines in the figure represent power lines, and the narrower lines depict signal lines. In the illustrated embodiment, the vehicle contains two batteries 40a and 40b. At any given time, one of the batteries supplies electrical power to the vehicle's drive motor, as well as the other electrical components of the vehicle. The other battery receives an electrical charge provided by the turbine generators until it is fully charged, after which it is placed in a standby state.

Alternating-current (AC) electrical energy is generated by the turbines 32, and is provided to a rectifier 42 to convert it to direct-current (DC) power. The output current of the rectifier might typically be 40 amperes. To increase the rate at which the batteries charge, it may be desirable to increase the output amperage, e.g., to 80 amps. This can be achieved by including a pulse-width-modulation (PWM) charger 43. Such a charger can be analogous to an at-home charger that e-vehicle owners typically install at their residences, e.g., in a garage, to provide overnight charging. The charger is preferably mounted on the interior wall of the compartment 20, outside of the duct, so as not to obstruct the flow of air to the turbines.

The DC power from the rectifier is provided to one of the two batteries by means of relay switches 44a and 44b that are respectively connected to the terminals of the two batteries. These switches are actuated by a controller 46. Each switch has three selectable positions that enable its associated battery to be placed in one of three states. In the case of battery 40a, its relay switch 44a is placed in the discharge (D) state, to connect the battery to an inverter 48. The inverter converts the DC output power of the battery to AC power, which is supplied to the vehicle's drive motor 50, as well as any auxiliary loads in the vehicle.

In an exemplary embodiment, the vehicle contains at least two drive motors 50, which are directly connected to the insides of the front wheels of the vehicle. By directly connecting the drive motors to the wheels, sufficient space is provided between them to accommodate the duct that houses the turbine generators 32.

While the battery 40a is supplying power to the drive motors, the relay switch 44b for the second battery 40b is set to the charge (C) state. In this position, the battery 40b is connected to the output terminal of the rectifier 42. Thus, in the illustrated configuration, the first battery 40a is providing the power to run the vehicle, while the second battery 40b is being charged by the energy provided from the turbines 32.

Each battery has an associated sensor 52 that monitors the charge level of the battery. When the charge level of the battery that is providing power to the motor 50, in this case battery 40a, falls to a predetermined level, e.g., 20%, its associated sensor 52a sends a first pulse to the controller 46 to indicate the low charge state. In response, the controller sends a command signal to the relay switch 44a to change from the discharge state (D) to the charge state (C). In this case, the battery is disconnected from the inverter 48, and connected to the rectifier 42 to receive power generated by the turbines 32. Concurrently, the relay switch for the other battery is switched to the discharge position (D), to begin supplying power to the motor 50 and other vehicle electronics.

While the battery 40a is being charged, its associated sensor 52a continues to monitor its charge level. When the charge level reaches a predetermined value, e.g., 80%, the sensor sends a second pulse to the controller 46. In response to this pulse signal, the controller causes the switch 44a to move to the neutral position (N). The battery 40a remains in the neutral state until such time as the charge level of the other battery 40b falls to the predetermined value for recharging, e.g., 20%, and its associated sensor 52b sends its first pulse to the controller 46. In response to this pulse, the controller causes the relay switch 44b to switch to the charge state (C), and commands the relay switch 44a to switch to the discharge state (D) to provide power from the battery 40a to the motor 50.

To facilitate retrofitting a conventional electric vehicle with the on-board turbine charging system of the present invention, the relay switches 44 and sensors 52 can be housed in a self-contained structure 64, indicated by dashed lines and identified as PJB 42.02. Similar to the charger 43, the structure comprises a container can be mounted on an interior wall of the compartment 20.

The container of the PJB 42.02 structure comprises two sections, or junction units, 64a and 64b, which are respectively associated with the two batteries. Each junction unit contains a relay switch 44 and a sensor 50 corresponding to its respective battery. In one complete cycle of operation, the structure generates four pulses, with the first two pulses coming from the sensor 52 of one of the junction units to respectively begin charging and stop charging of the battery associated with that unit, followed by two pulses from the sensor 52 of the other junction unit, to start and stop charging of the other battery associated with the latter junction unit.

The turbine charging system is complementary to a conventional EV charging system. To this end, the vehicle has a standard connector, or socket, 54 for attachment to an external source of power, e.g., a charging station 56. This socket is connected to the batteries in parallel with the output terminal of the rectifier 42 that supplies the power generated by the turbines. When the external source 56 is connected to the vehicle, the socket 54 sends a signal to the controller 46. In this situation, the controller sets the relay switch 44 associated with one of the batteries to the charge (C) state, e.g., the battery having the lower charge level, so that this battery is charged by the external source.

As noted previously, the vanes 16 are movable, to control the flow of air through the enclosed compartment of the turbine section 24 while the vehicle is moving. One or more motors 60 adjust the position of the vanes. The controller 46 receives a signal from a wind sensor 62 located within the turbine compartment, and sends commands to the motor 60 to adjust the vanes so as to obtain a desired wind speed therein.

Highly efficient turbine generators, such as the exemplary embodiment described previously, can generate electricity at almost any wind speed. In such case, it may not be necessary to regulate the wind speed within the duct 18. In other situations, the wind turbines may only be efficient within a particular range of wind velocity. To obtain efficient generation of electricity under those circumstances, the controller 46 can adjust the positions of the vanes to maintain a wind speed within the compartment 20 that is in a preferred range, e.g., 14-20 mph, irrespective of the vehicle's speed. Thus, at low vehicle speeds that are not sufficient to induce at least a 14-mph windspeed within the compartment, the controller can instruct the motor 60 to close the vanes, and thereby inhibit the turbines from operating. Once the vehicle reaches a speed that is sufficient to generate power, the controller can cause the vanes to open an amount sufficient to maintain windspeed in the compartment within the desired range.

In summary, one or more turbines located within an electric vehicle are caused to rotate by relative airflow resulting from the movement of the vehicle. Electricity generated by this rotation can be selectively applied to one or more batteries in the vehicle, to recharge the batteries. As such, the need to stop the vehicle to recharge the batteries from an external source can be eliminated, or at least substantially reduced.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. For example, the number of wind turbines, the number of batteries, and the speed of the vehicle at which power generation occurs, can all be varied to achieve the desired on-board charging. Likewise, while the disclosed embodiment comprises wind turbines within a compartment of the vehicle, in an alternate embodiment the turbines can be located on the exterior of the vehicle, e.g., on its roof. Such modifications are within the ability of one skilled in the art, and form a part of the present invention and are embraced by the appended claims.

1. An on-board charging system for an electric vehicle, comprising:
at least one wind turbine mounted to the electric vehicle so as to intercept relative air movement created by motion of the vehicle, and to generate electricity therefrom;
a switch for selectively connecting an output terminal of the wind turbine to a battery located in the vehicle; and
a controller that actuates the switch to connect the output terminal of the wind turbine to the battery when the charge level of the battery is below a specified level and the wind turbine is generating electricity.

2. The charging system of claim 1, wherein:
the vehicle contains first and second batteries each having an associated switch, and
the controller actuates the switch associated with the first battery to connect that battery to the output terminal of the wind turbine, and actuates the switch associated with the second battery to connect that battery to an electric motor of the vehicle.

3. The charging system of claim 2, wherein:
the controller monitors the charge level of each of the two batteries, and
when the charge level of the first battery connected to the wind turbine reaches a predetermined level, the controller actuates its associated switch to disconnect the first battery from the output terminal of the wind turbine.

4. The charging system of claim 2 wherein:
the controller monitors the charge level of each of the two batteries, and
when the charge level of the second battery connected to the electric motor descends to a predetermined level, the controller actuates its associated switch to connect the second battery to the output terminal of the wind turbine, and actuates the switch associated with the first battery to connect the first battery to the electric motor of the vehicle.

5. The charging system of 2 wherein:
the vehicle includes a socket for receiving electrical power from a charger located exterior of the vehicle,
the controller monitors the status of the socket, and
when the controller detects that the vehicle is connected to an external source of power, it activates a switch to disconnect both of the batteries from the wind turbine, and connect at least one of the batteries to the external source of power.

6. The charging system of claim 1, wherein the at least one wind turbine is located in a compartment that has an opening at the forward end of the vehicle to permit air to enter the compartment when the vehicle is in motion, a central section in which the at least one turbine is located, to receive the incoming air, and an opening at the rear of the compartment to permit the air to exhaust after passing by the at least one turbine.

7. The charging system of claim 6, wherein the compartment includes at least one movable barrier to control the flow of air into the compartment.

8. The charging system of claim 7, wherein the controller monitors the rate of airflow in the compartment, and controls the movable barrier to maintain the airflow within a predetermined range.

9. The charging system of claim 8, wherein the predetermined range is 14-20 miles per hour.

10. The charging system of claim 6, comprising at least two wind turbines within the compartment, wherein the wind turbines are spaced horizontally across the width of the compartment to be exposed to different portions of the air flowing through the compartment.

11. The charging system of claim 10, wherein a first wind turbine is oriented to face the front of the vehicle, and at least one other wind turbine is oriented at an acute angle relative to the orientation of the first wind turbine.

12. The charging system of claim 11, wherein the acute angle is approximately 45 degrees.

13. The charging system of claim 2, wherein each battery has an associated sensor that is responsive to the charge level of the respective battery to send signals to the controller to initiate and terminate charging of the battery, and wherein the switches and sensors associated with the batteries are housed within a self-contained structure that is mountable within the electric vehicle.

14. The charging system of claim 13, wherein the self-contained structure comprises separate compartments that are respectively associated with the batteries, and wherein each compartment contains the switch and sensor associated with its respective battery.

15. A self-contained structure for operating an on-board battery charging system of an electric vehicle, the structure comprising:
a plurality of charge-level sensors that are respectively associated with each of a plurality of batteries in the electric vehicle, each sensor being adapted to be connected to its respective battery for detecting the charge level of the battery, and operative to send a first signal when the detected charge level falls to a first predetermined value, and send a second signal when the detected charge level rises to a second predetermined value, and
a plurality of switches respectively associated with the plurality of batteries in the electric vehicle, each switch being connectable to a terminal of its respective battery and being switchable to a first position to connect the battery to the on-board charging system when that battery's associated sensor sends the first signal, and switchable to a second position to connect the battery to an electric motor of the vehicle after the associated sensor sends the second signal; and
a container in which the plurality of sensors and plurality of switches are housed.

16. The self-contained structure of claim 15, wherein the container comprises a plurality of compartments that are respectively associated with the plurality of batteries, and wherein each compartment contains a sensor and a switch associated with its respective battery.
